(19) United States
(12) Patent Application Publication
(10) Pub. No.: US 2009/0053369 A1
(43) Pub. Date: Feb. 26, 2009

(54) JELLY CANDY

(76) Inventor: Seon Yeol Seok, Hamyang-gun (KR)

Correspondence Address: IPLA P.A., 3580 WILSHIRE BLVD., 17TH FLOOR, LOS ANGELES, CA, 90010, US

(21) Appl. No.: 11/719,744

(22) PCT Filed: Nov. 18, 2005
(86) PCT No.: PCT/KR05/03910

§ 371 Date: May 18, 2007

(30) Foreign Application Priority Data
Nov. 19, 2004 (KR) 20-2004-0032815

(51) Int. Cl. A23G 3/50

(52) U.S. Cl. 426/104

(57) ABSTRACT

A jelly candy is disclosed, which is capable of preventing an obstruction of an airway of a human body when eating the jelly candy, with a vertical through hole being formed at a center in an axial direction of a jelly.

### TECHNICAL FIELD

The present invention relates to a jelly candy inputted into a small container with a cover being attached on an upper side of the container, and in particular to a jelly candy which is capable of preventing an obstruction of an airway of a human body when eating the jelly candy, with a vertical through hole being formed at a center in an axial direction of a jelly.

### BACKGROUND ART

Generally, a jelly candy is fabricated in such a manner that a jelly is inputted into a container with an open upper side, and a cover is sealingly attached on a rim of the container based on a high frequency melting method. As shown in FIG. 1, a jelly 2 is inputted into a storing container 1 with an open upper side, and a cover 3 is sealingly attached to a rim of the storing container 1 based on a high frequency melting method. When children eat the jelly, the cover 3 is removed, and the jelly is inputted into a mouth through an opened upper side of the storing container 1. With the above construction, when the user strongly presses the sides of the storing container 1, the jelly may be fast inputted into the mouth with a piston operation, so that the airway may be blocked by the jelly. Generally, the jelly candy is inputted into the storing container with an open upper side, and the cover is sealingly attached to the rim of the storing container by a high frequency melting method. FIG. 1 is a view illustrating a construction that the jelly 2 is inputted into the storing container 1 with an open upper side, and a thin cover 3 is attached to the upper rim of the storing container based on a high frequency melting method. When children eat the jelly, the cover 3 is removed, and the jelly is inputted into the mouth through the opened upper side of the storing container 1. In this case, when strongly pressing the sides of the storing container 1 without careful removing the cover, the jelly may be fast inputted into the mouth with a piston operation, so that the airway may be blocked.

### DISCLOSURE OF INVENTION

Accordingly, it is an object of the present invention to overcome the problems encountered in the conventional art.

It is another object of the present invention to provide a jelly candy which allows an eater of a jelly candy to breath even when the jelly blocks the airway.

It is further another object of the present invention to provide a jelly candy which allows an eater of a jelly can to breath irrespective of the blocking position of the jelly.

To achieve the above objects, there is provided a jelly candy which comprises a through hole formed in an axial direction of a jelly for thereby allowing an eater to breath even when the jelly blocks the airway of the eater. Preferably, the through hole is formed in such a manner that the upper and lower paths and the outer surface of the jelly communicate, so that the airway always communicates with the paths.

To achieve the above objects, in a jelly candy which is stored in a small container, with a cover being attached to an upper side of the container, there is provided a jelly candy characterized in that a vertical through hole passing through the upper and lower surface of the jelly is formed at a center of the jelly in an axial direction of the same.

At least one small path extending from the through hole to the outer surface is formed at the upper and lower surfaces of the jelly.

A jelly candy is stored in an additional casing, the casing comprising a container having a protrusion pipe upwardly protruded from the bottom for thereby defining a through hole vertically passing through the jelly, and a cover having a protrusion band protruded in a radial direction for thereby defining a path communicating with the through hole, and a protrusion ban is formed at the bottom of the container and is protruded upwards in a radial direction for thereby defining a path communicating with the through hole of the jelly.

The jelly is formed in a shape selected among the shapes of a flow leave shape, a star shape, etc.

### BRIEF DESCRIPTION OF THE DRAWINGS

FIG. 1 is a cross sectional view illustrating a conventional jelly candy.

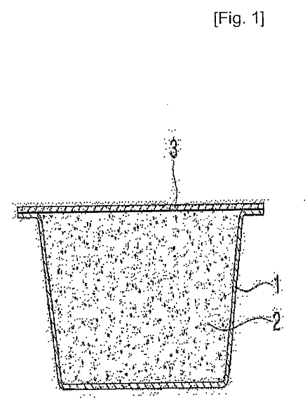

FIG. 2 is a disassembled perspective view illustrating a jelly candy according to the present invention.

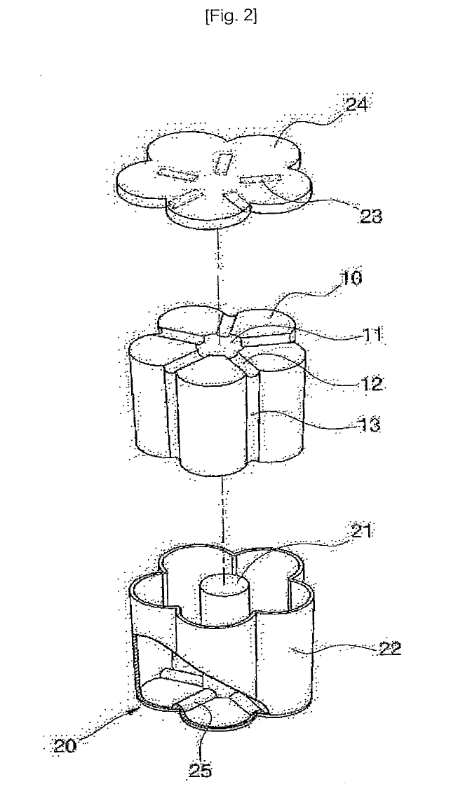

FIG. 3 is a plane view illustrating an assembled state according to the present invention.

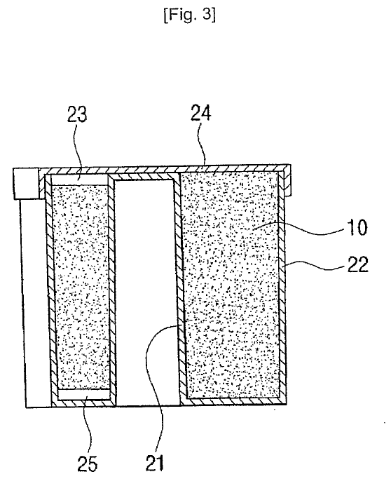

FIG. 4 is a plane view illustrating a jelly candy according to another embodiment of the present invention.

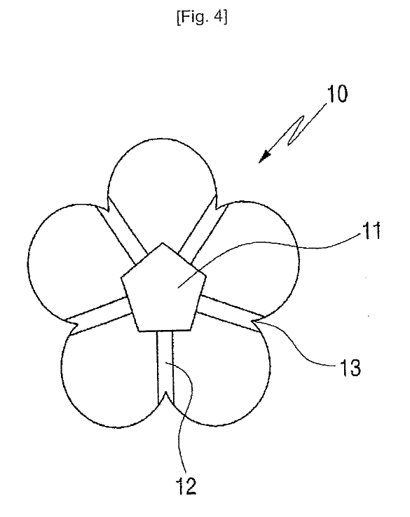

FIG. 5 is a plane view illustrating a jelly candy according to further another embodiment of the present invention.

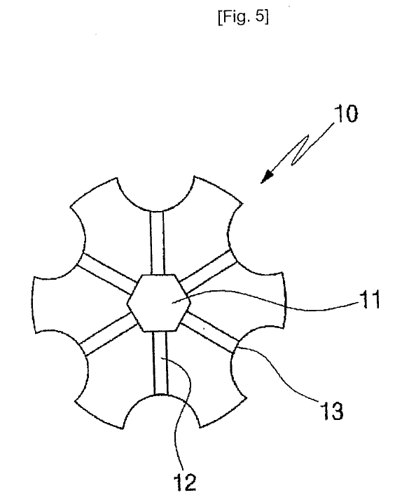

FIG. 6 is a plane view illustrating a jelly candy according to still another embodiment of the present invention.

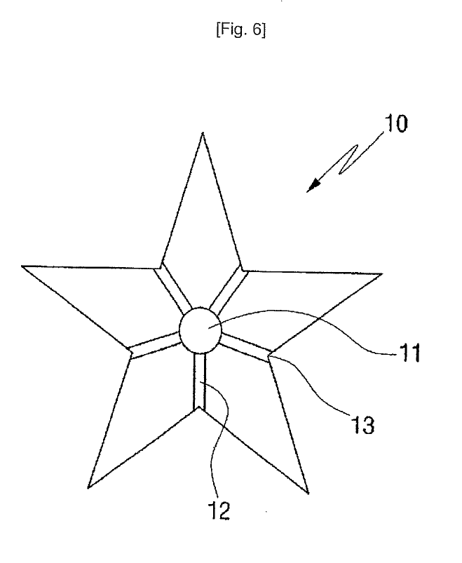

### BEST MODE FOR CARRYING OUT THE INVENTION

The preferred embodiments of the present invention will be described with reference to the accompanying drawings.

At least one small path 12 is formed at the upper and lower surfaces of the jelly 10, with the path being communicated from a through hole 11 to an outer surface of the same. The path 12 is formed at both the upper and lower surfaces. The upper and lower paths 12 communicate with a groove 13 formed at an outer surface of the jelly 10 in a longitudinal direction. In the jelly 10, the groove 13 is concave and formed at an outer surface of the same in the longitudinal direction.

When repeating the above construction, at least one small path 12 is formed at the upper and lower surfaces of the jelly 10, with the path being communicated from a through hole 11 to an outer surface of the same. The path 12 is formed at both the upper and lower surfaces. The upper and lower paths 12 communicate with a groove 13 formed at an outer surface of the jelly 10 in a longitudinal direction. In the jelly 10, the groove 13 is concave and formed at an outer surface of the same in the longitudinal direction.

Here, the jelly candy is stored in a casing 20. The casing 20 comprises a container 22 having a protrusion pipe 21 protruded from the bottom to an upper side so that a through hole 11 is formed at the jelly 10 stored in the casing 20, and a cover 24 which has a protrusion band 23 protruded in a radial direction so that a path communicating with the through hole 11 is formed. A protrusion band 25 is upwardly protruded in a radial direction and communicates with the through hole 11 of the jelly 10 stored in the container 22. The container 22 has a diameter which increases in an upper direction, so that the jelly can be easily discharged.

Here, preferably one through hole 11 is formed. If needed, at least two through holes 11 may be provided.

The jelly 10 may be formed in various shapes such as flower leaves, star, etc. based on the arrangement of the groove 13.

In the present invention, the container 22 having a certain shape is used (it has a protrusion pipe 21 at the bottom center of the same, with the protrusion pipe 21 being upwardly extended). A jelly source is inputted into the container 22, and the cover 24 is covered. The jelly is hardened. Since the protrusion band 25 is formed at the bottom of the container 22, a groove (path 12) is formed at the bottom of the jelly 10. The path 12 is formed by the protrusion band 23 of the cover 24.

The protrusion pipe 21 is formed at the bottom center of the container 22 during the molding process, so that the through hole 11 is formed at the jelly 10.

In a state that the jelly 10 is received in the container 22, the user opens the cover 24 and presses the container 22. In this case, the container 22 has a diameter which increases upwards. When the bottom is pressed, the jelly 10 is naturally moved up. Even when the jelly blocks the airway of the eater, the eater can continuously breathe through the through hole 11. The groove 13 is formed at the outer surface of the jelly 10 at regular intervals in the longitudinal direction, so that the groove 13, the path 12 and the through hole 11 provide air paths, whereby it is possible to prevent the block of airway when eating the jelly candy.

### INDUSTRIAL APPLICABILITY

As described above, in the present invention, since the through hole is formed in the axial direction of the jelly, even when the jelly blocks the airway of the eater, the eater can breathe, so that it is possible to achieve a safety when eating the jelly.

In the present invention, an additional path is formed at the upper and lower surfaces, with the path communicating with the through hole and the groove formed at the outer surface of the jelly at regular intervals. With the above construction, even when the jelly blocks the eater's airway, it is possible to protect the eater. The protrusions defining the groove at the outer surface of the jelly may be formed in flower leave shapes or start shapes. The customers can be satisfied with the various shapes.

In the present invention, the grooves are formed at the outer surface of the container which stores jelly therein. The protrusion pipe is formed at the center of the container, with the protrusion pipe being protruded upwards. With this construction, when the jelly is stored in the container, it is possible to fabricate the grooves and paths at the jelly without additional forming procedures.

In the present invention, the upper and lower through hole is formed in the axial direction of the jelly. Even when the jelly blocks the airway, the eater can breathe through the through hole. Preferably, the through hole communicates with the path formed at the upper and lower surfaces and the grooves of the outer surface, so that the airway is open in any directions.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a jelly candy which is stored in a small container, with a cover being attached to an upper side of the container, a jelly candy characterized in that a vertical through hole 11 passing through the upper and lower surface of the jelly is formed at a center of the jelly 10 in an axial direction of the same.

2. The candy of claim 1, wherein at least one small path 12 extending from the through hole 11 to the outer surface is formed at the upper and lower surfaces of the jelly 10.

3. The candy of claim 1, wherein a jelly candy is stored in an additional casing 20, said casing 20 comprising a container 22 having a protrusion pipe 21 upwardly protruded from the bottom for thereby defining a through hole 11 vertically passing through the jelly 10, and a cover 24 having a protrusion band 23 protruded in a radial direction for thereby defining a path communicating with the through hole 11, and a protrusion ban 25 is formed at the bottom of the container 22 and is protruded upwards in a radial direction for thereby defining a path communicating with the through hole 11 of the jelly 10.

4. The candy of claim 1, wherein said jelly 10 is formed in a shape selected among the shapes of a flow leave shape, a star shape, etc.
